(19) United States
(12) Patent Application Publication
(10) Pub. No.: US 2025/0358564 A1
(43) Pub. Date: Nov. 20, 2025

(54) SPEAKER MODULE

(71) Applicant: AAC Microtech (Changzhou) Co., Ltd., Changzhou City (CN)

(72) Inventors: Xin Jin, Changzhou (CN); Wei Song, Changzhou (CN); Jie Ma, Changzhou (CN); Yun Tang, Changzhou (CN)

(21) Appl. No.: 18/986,798

(22) Filed: Dec. 19, 2024

Related U.S. Application Data
(63) Continuation of application No. PCT/CN2024/094284, filed on May 20, 2024.

(51) Int. Cl. H04R 1/28; H04R 7/06; H04R 9/02; H04R 9/04; H04R 9/06

(52) U.S. Cl. CPC H04R 1/288; H04R 7/06; H04R 9/025; H04R 9/045; H04R 9/06; H04R 2400/11

(57) ABSTRACT

A speaker module is provided, including a mounting frame, a damping structure, and a speaker assembly. The damping structure is disposed on the mounting frame. The speaker assembly includes a vibration system and a magnetic circuit system, the magnetic circuit system is configured to drive the vibration system to vibrate, the magnetic circuit system includes an upper clamping plate and an anti-overflow layer, the upper clamping plate is disposed on a top portion of the damping structure, the anti-overflow layer is disposed on a surface of the first main body around a perimeter of the first platform, and the anti-overflow layer is configured to prevent raw materials of the damping structure from overflowing in a molding process. No additional part is needed for mounting the anti-overflow layer, which is simple and efficient in implementation and further low in production cost.

### TECHNICAL FIELD

The present disclosure relates to the field of electroacoustics, and in particular to a speaker module.

### BACKGROUND

Mobile electronic devices in the related art are more and more functionable with its popularization, and a high-quality music function becomes one of the most common functions in the mobile electronic devices, leading to widespread application of speakers for sound playing in the mobile electronic devices. In the related art, each of the speakers is provided with a damping structure for enhancing shock resistance, so as to prevent damage to the speakers when the speakers are subjected to strong impacts, thereby improving reliability of both the speakers and the mobile electronic devices. However, in a molding process of a current damping structure, there is a clearance between a magnetic circuit structure and a molded jig due to multiple height tolerance accumulation in the magnetic circuit structure in a corresponding speaker, thereby preventing a precise fit. Consequently, damping materials overflow, a vibration space for a voice coil is reduced, and performance of the corresponding speaker is ultimately affected.

Therefore, it is necessary to provide a speaker module capable of preventing damping materials thereof from overflowing in a molding process thereof.

### SUMMARY

The present disclosure aims to provide a speaker module capable of preventing damping materials thereof from overflowing in a molding process thereof.

Technical solutions of a first aspect of the present disclosure are as following.

The present disclosure provides the speaker module, including a mounting frame, a damping structure, and a speaker assembly. The damping structure is disposed on the mounting frame. The speaker assembly includes a vibration system and a magnetic circuit system, the magnetic circuit system is configured to drive the vibration system to vibrate, the magnetic circuit system includes an upper clamping plate and an anti-overflow layer, the upper clamping plate is disposed on a top portion of the damping structure, and the anti-overflow layer is disposed on the upper clamping plate. The upper clamping plate includes a first main body, a first hole structure, and a first platform, the first hole structure is disposed at a middle portion of the first main body, and the first platform protrudes upward along an edge area of the first hole structure. The anti-overflow layer is disposed on a surface of the first main body around a perimeter of the first platform, and the anti-overflow layer is configured to prevent raw materials of the damping structure from overflowing in a molding process.

As an improvement, the damping structure is disposed at an inner side of the mounting frame. The mounting frame includes a second main body and two first side plates, and the two first side plates are vertically disposed on the second main body in a first direction. The damping structure includes a third main body, two second side plates, and two third side plates, the two second side plates and the two third side plates are respectively vertically disposed at edge areas of the third main body in the first direction, the third main body is disposed on the second main body, the two second side plates are respectively connected to the two first side plates, and the two third side plates are disposed between the two second side plates.

As an improvement, the two third side plates extend outward from a plane defined by the first main body, a portion of the anti-overflow layer corresponding to the two third side plates is filled between an outer wall of the first platform and inner walls of the two third side plates.

As an improvement, each of the two second side plates includes a connecting structure connected to a corresponding one of the two first side plates, each of the two first side plates includes a matching structure matched with a corresponding connecting structure. The second main body is of an annular structure, a second hole structure is disposed at a middle portion of the second main body, a first mounting groove is defined on the second hole structure, and the third main body is connected to the first mounting structure.

As an improvement, the magnetic circuit system further includes a lower clamping plate, an inner magnetic steel, a side magnetic steel, an outer magnetic steel, and a pole core, the lower clamping plate is disposed on the third main body, the inner magnetic steel is disposed on an area of the lower clamping plate corresponding to the first hole structure, the side magnetic steel is disposed between the first main body and the lower clamping plate, the outer magnetic steel is disposed above the inner magnetic steel, and the pole core is clamped between the outer magnetic steel and the inner magnetic steel. The outer magnetic steel protrudes from the first hole structure. The side magnetic steel is disposed along a circumferential direction of the inner magnetic steel, a gap is defined between the inner magnetic steel and the first hole structure.

As an improvement, the vibration system includes an inner vibrating diagram, a framework, an upper vibrating diagram, a voice coil, and two lower vibrating diagrams. The inner vibrating diagram is disposed above the outer magnetic steel, the framework is disposed at a periphery of the inner vibrating diagram, the upper vibrating diagram is disposed at a periphery of the framework, the voice coil is suspended in the gap, and the two lower vibrating diagrams are respectively disposed at outer sides of the two third side plates.

As an improvement, the speaker module further includes two flexible circuit boards (FCBs), the two FCBs are respectively disposed on the two lower vibrating diagrams and are electrically connected to the voice coil, the framework is connected to the two FCBs and is configured to support the vibration system on the two FCBs, and each of the two lower vibrating diagrams is concave from top to bottom.

As an improvement, the framework includes a fourth main body and two fourth side plates, the fourth main body is connected between the inner vibrating diagram and the upper vibrating diagram, the two fourth side plates are respectively vertically disposed at side edges, corresponding to the two FCBs, of the fourth main body, and the two fourth side plates are respectively connected to inner sides of the two FCBs. The upper vibrating diagram includes a fifth main body and two fifth side plates, the fifth main body is connected to the workframe, the two fifth side plates are respectively vertically disposed at side edges, corresponding to the two FCBs, of the fifth main body, and the two fifth side plates are respectively connected to outer sides of the two FCBs.

As an improvement, connecting lugs are disposed on side edges, corresponding to the two second side plates, of the first main body, a top portion of each of the two second side plates defines a second mounting groove, and each second mounting groove is matched with a corresponding one of the connecting lugs.

As an improvement, the damping structure is a flexible damping structure, and the anti-overflow layer is a flexible glue layer.

Beneficial effects of the present disclosure are as following.

The speaker module of the present disclosure provides the anti-overflow layer on the first main body, in the molding process of the dumping structure, a clearance between a molded jig and the upper clamping plate is compensated by the anti-overflow layer, thereby preventing the raw materials of the damping structure from overflowing, in this way, vibration space of the voice coil in the speaker module is ensured, thereby improving performance of a corresponding speaker. Moreover, no additional part is needed for mounting the anti-overflow layer, which is simple and efficient in implementation and further low in production cost.

### BRIEF DESCRIPTION OF DRAWINGS

FIG. 1 is a structural schematic diagram of a speaker module of the present disclosure.

FIG. 2 is a cross-sectional schematic diagram taken along the line A-A of FIG. 1.

FIG. 3 is a cross-sectional schematic diagram taken along the line B-B of FIG. 1.

FIG. 4 is an exploded schematic diagram of the speaker module of the present disclosure.

FIG. 5 is an assembly schematic diagram of an upper clamping plate, an anti-overflow layer, and a damping structure.

FIG. 6 is a cross-sectional schematic diagram taken along the line C-C of FIG. 5.

FIG. 7 is a cross-sectional schematic diagram taken along the line D-D of FIG. 5.

### DETAILED DESCRIPTION OF EMBODIMENTS

The present disclosure is further described below with reference to the accompanying drawings and embodiments.

### Embodiments

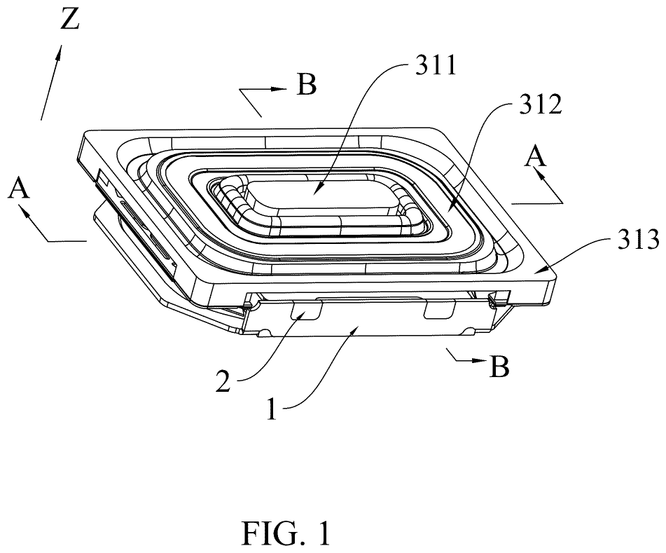

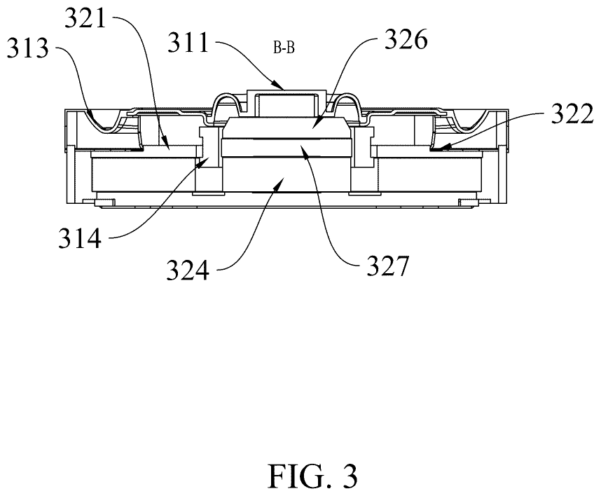

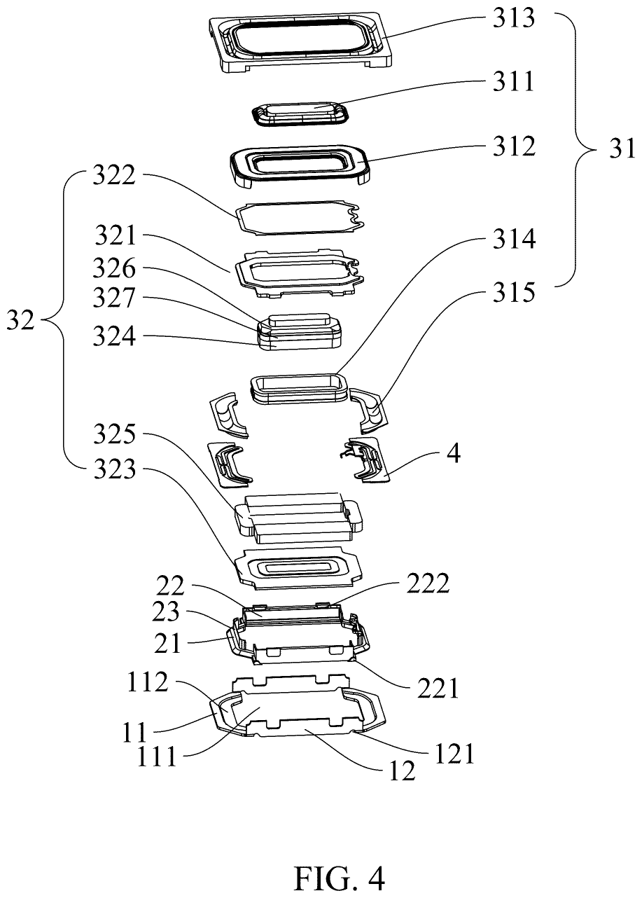

The embodiments of the present disclosure provide a speaker module, as shown in FIGS. 1-4, including a mounting frame 1, a damping structure 2, and a speaker assembly 3. The damping structure 2 is disposed on the mounting frame 1. The speaker assembly 3 includes a vibration system 31 and a magnetic circuit system 32, the magnetic circuit system 32 is configured to drive the vibration system 31 to vibrate, the magnetic circuit system 32 includes an upper clamping plate 321 and an anti-overflow layer 322, the upper clamping plate 321 is disposed on a top portion of the damping structure 2, and the anti-overflow layer 322 is disposed on the upper clamping plate 321. The upper clamping plate 321 includes a first main body 3211, a first hole structure 3212, and a first platform 3214, the first hole structure 3212 is disposed at a middle portion of the first main body 3211, and the first platform 3214 protrudes upward along an edge area of the first hole structure 3212. The anti-overflow layer 322 is disposed on a surface of the first main body 3211 around a perimeter of the first platform 3214, and the anti-overflow layer 322 is configured to prevent raw materials of the damping structure 2 from overflowing in a molding process.

According to the present disclosure, the anti-overflow layer 322 is disposed on an upper surface of the first main body 3211, in the molding process of the dumping structure 2, a clearance between a molded jig and the upper clamping plate 321 is compensated by the anti-overflow layer 322, thereby preventing the raw materials of the damping structure 2 from overflowing, in this way, vibration space of the speaker assembly 3 is ensured, thereby improving performance of a corresponding speaker. Moreover, no additional part is needed for mounting the anti-overflow layer 322, which is simple and efficient in implementation and further low in production cost. It should be noted that, in the embodiments of the present disclosure, in a direction refers to a direction away from the mounting frame 1 along a first direction z, and the first direction z is perpendicular to a plane parallel to the first main body 3211. In the present disclosure, the first direction z is a direction parallel to the vibration direction

The damping structure 2 is disposed at an inner side of the mounting frame 1. The mounting frame 1 includes a second main body 11 and two first side plates 12, and the two first side plates 12 are vertically disposed on the second main body in a first direction z. The damping structure 2 includes a third main body 21, two second side plates 22, and two third side plates 23, the two second side plates 22 and the two third side plates 23 are respectively vertically disposed at edge areas of the third main body 21 in the first direction z, the third main body 21 is disposed on the second main body 11, the two second side plates 22 are respectively connected to the two first side plates 21, and the two third side plates 23 are disposed between the two second side plates 22. Top surfaces of the two second side plates 22 are flush with a plane defined by the first main body 3211. When the speaker module is subjected to impacts, the damping structure 2 is configured to buffers an impact force, so as to prevent the speaker assembly 3 from being impacted to affect sound production quality or cause internal part damage.

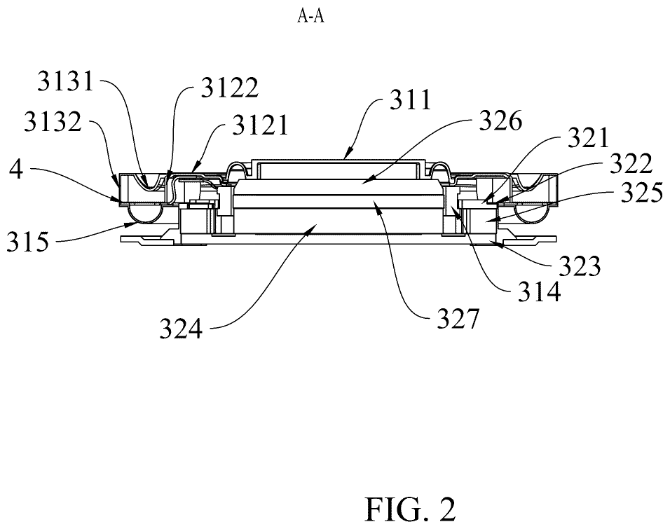

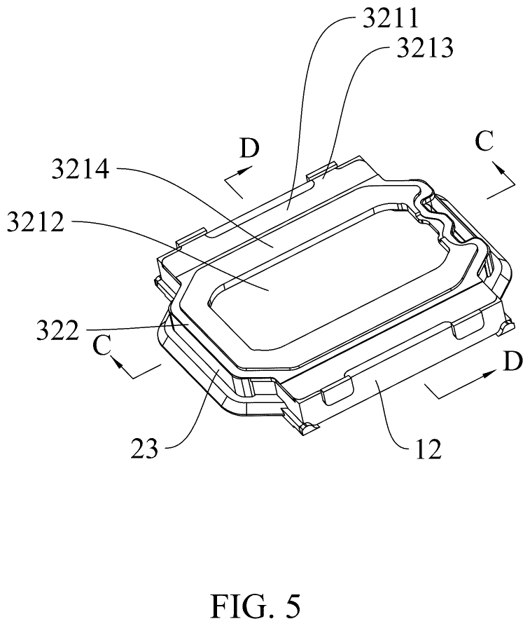

As shown in FIGS. 2 and 5, the two third side plates 23 extend outward from the plane defined by the first main body 3211, a portion of the anti-overflow layer 322 corresponding to the two third side plates 23 is filled between an outer wall of the first platform 3214 and inner walls of the two third side plates 23. In the embodiments, there are height differences respectively between the two second side plates 22 and the two third side plates 23 and between the two second side plates 22 and the first main body 3211, and the anti-overflow layer 322 is configured to prevent the raw materials of the damping structure 2 from overflowing to the speaker assembly 3 in a molding process of the corresponding speaker, in this way, molding quality of the corresponding speaker, a damping effect of the damping structure 2, and the performance of the corresponding speaker are further enabled.

Furthermore, each of the two second side plates 22 includes a connecting structure 221 connected to a corresponding one of the two first side plates 12, each of the two first side plates 12 includes a matching structure 121 matched with a corresponding connecting structure 221. Specifically, in some embodiments, each connecting structure 221 is a protruding structure disposed on an outer wall of a corresponding one of the two second side plates 22, each matching structure 121 is a groove defined in a corresponding one of the two first side plates 12 and is matched and connected with a corresponding protruding structure, and each protruding structure is embedded in a corresponding groove. Connection strength between each of the two second side plates 22 and a corresponding one of the two first side plates 12 is improved through matching and connection between the corresponding connecting structure 221 and a corresponding matching structure 121. The second main body 11 is of an annular structure, a second hole structure 111 is disposed at a middle portion of the second main body 11, a first mounting groove 112 is defined on the second hole structure 111, and the third main body 21 is connected to the first mounting structure 112.

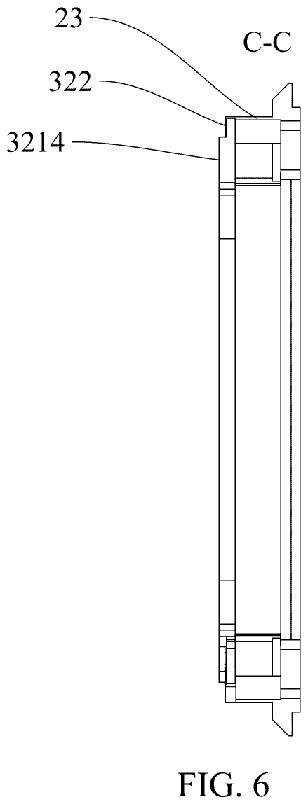

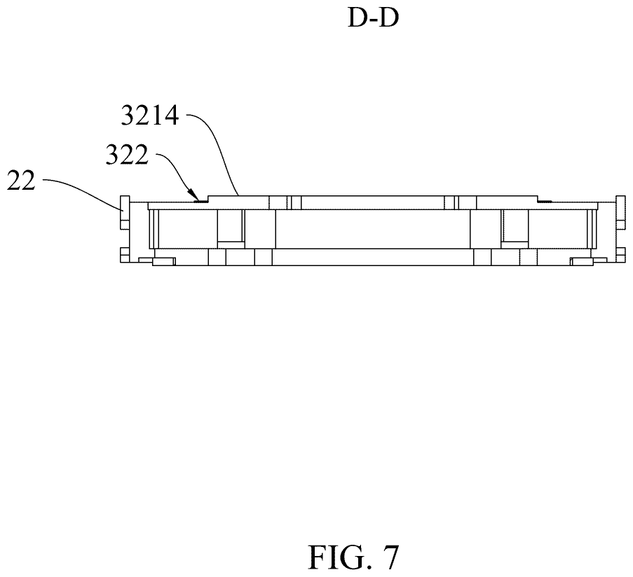

As shown in FIGS. 2-7, the magnetic circuit system 32 further includes a lower clamping plate 323, an inner magnetic steel 324, a side magnetic steel 325, an outer magnetic steel 326, and a pole core 327. The lower clamping plate 323 is disposed on the third main body 21, the inner magnetic steel 324 is disposed on an area of the lower clamping plate 323 corresponding to the first hole structure 3212, the side magnetic steel 325 is disposed between the first main body 11 and the lower clamping plate 323, the outer magnetic steel 326 is disposed above the inner magnetic steel 324, and the pole core 327 is clamped between the outer magnetic steel 326 and the inner magnetic steel 324. The outer magnetic steel 326 protrudes from the first hole structure 3212. The side magnetic steel 325 is disposed along a circumferential direction of the inner magnetic steel 324, a gap is defined between the inner magnetic steel 324 and the first hole structure 3212.

The vibration system 31 includes an inner vibrating diagram 311, a framework 312, an upper vibrating diagram 313, a voice coil 314, and two lower vibrating diagrams 315. The inner vibrating diagram 311 is disposed above the outer magnetic steel 326, the framework 312 is disposed at a periphery of the inner vibrating diagram 311, the upper vibrating diagram 313 is disposed at a periphery of the framework 312, the voice coil 314 is suspended in the gap, and the two lower vibrating diagrams 315 are respectively disposed at outer sides of the two third side plates 315.

The speaker module further includes two flexible circuit boards (FCBs) 4, the two FCBs 4 are respectively disposed on the two lower vibrating diagrams 315 and are electrically connected to the voice coil 314, the framework 312 is connected to the two FCBs 4 and is configured to support the vibration system 31 on the two FCBs 4, and each of the two lower vibrating diagrams 315 is concave from top to bottom. The “upper” herein refers to a direction close to the lower clamping plate 323 along the first direction z, and the “lower” herein refers to a direction away from the lower clamping plate 323 along the first direction z.

The framework 312 includes a fourth main body 3121 and two fourth side plates 3122, the fourth main body 3121 is connected between the inner vibrating diagram 311 and the upper vibrating diagram 313, the two fourth side plates 3122 are respectively vertically disposed at side edges, corresponding to the two FCBs 4, of the fourth main body 3121, and the two fourth side plates 3122 are respectively connected to inner sides of the two FCBs 4. The upper vibrating diagram 313 includes a fifth main body 3131 and two fifth side plates 3132, the fifth main body 3131 is connected to the workframe 312, the two fifth side plates 3132 are respectively vertically disposed at side edges, corresponding to the two FCBs 4, of the fifth main body 3131, and the two fifth side plates 3132 are respectively connected to outer sides of the two FCBs 4. It should be noted that, the “inner” herein refers to a direction close to a central axis of the first hole structure 3212, and the “outer” herein refers to a direction away from the central axis of the first hole structure 3212.

Furthermore, connecting lugs 3213 are disposed on side edges, corresponding to the two second side plates 22, of the first main body 3211, a top portion of each of the two second side plates 22 defines a second mounting groove 222, and each second mounting groove 222 is matched with a corresponding one of the connecting lugs 3213. Each of the connecting lugs 3213 is embedded in a corresponding second mounting groove 222.

As an improvement, the damping structure 2 is a flexible damping structure, and the anti-overflow layer 322 is a flexible glue layer. Specifically, the damping structure 2 is made of a rubber material.

The foregoing are merely embodiments of the present disclosure, and it should be noted that, for those who skilled in the art, improvements can be made without departing from the concepts of the present disclosure, but these are all within the protection scopes of the present disclosure.

What is claimed is:

1. A speaker module, comprising:
a mounting frame;
a damping structure; and
a speaker assembly;
wherein the damping structure is disposed on the mounting frame;
the speaker assembly comprises a vibration system and a magnetic circuit system, the magnetic circuit system is configured to drive the vibration system to vibrate, the magnetic circuit system comprises an upper clamping plate and an anti-overflow layer, the upper clamping plate is disposed on a top portion of the damping structure, and the anti-overflow layer is disposed on the upper clamping plate;
the upper clamping plate comprises a first main body, a first hole structure, and a first platform, the first hole structure is disposed at a middle portion of the first main body, and the first platform protrudes upward along an edge area of the first hole structure; and
the anti-overflow layer is disposed on a surface of the first main body around a perimeter of the first platform, and the anti-overflow layer is configured to prevent raw materials of the damping structure from overflowing in a molding process.

2. The speaker module according to claim 1, wherein the damping structure is disposed at an inner side of the mounting frame;
the mounting frame comprises a second main body and two first side plates, and the two first side plates are vertically disposed on the second main body in a first direction; and
the damping structure comprises a third main body, two second side plates, and two third side plates, the two second side plates and the two third side plates are respectively vertically disposed at edge areas of the third main body in the first direction, the third main body is disposed on the second main body, the two second side plates are respectively connected to the two first side plates, and the two third side plates are disposed between the two second side plates.

3. The speaker module according to claim 2, wherein the two third side plates extend outward from a plane defined by the first main body, a portion of the anti-overflow layer corresponding to the two third side plates is filled between an outer wall of the first platform and inner walls of the two third side plates.

4. The speaker module according to claim 2, wherein each of the two second side plates comprises a connecting structure connected to a corresponding one of the two first side plates, each of the two first side plates comprises a matching structure matched with a corresponding connecting structure; and
the second main body is of an annular structure, a second hole structure is disposed at a middle portion of the second main body, a first mounting groove is defined on the second hole structure, and the third main body is connected to the first mounting structure.

5. The speaker module according to claim 2, wherein the magnetic circuit system further comprises a lower clamping plate, an inner magnetic steel, a side magnetic steel, an outer magnetic steel, and a pole core, the lower clamping plate is disposed on the third main body, the inner magnetic steel is disposed on an area of the lower clamping plate corresponding to the first hole structure, the side magnetic steel is disposed between the first main body and the lower clamping plate, the outer magnetic steel is disposed above the inner magnetic steel, and the pole core is clamped between the outer magnetic steel and the inner magnetic steel;
the outer magnetic steel protrudes from the first hole structure; and
the side magnetic steel is disposed along a circumferential direction of the inner magnetic steel, a gap is defined between the inner magnetic steel and the first hole structure.

6. The speaker module according to claim 5, wherein the vibration system comprises an inner vibrating diagram, a framework, an upper vibrating diagram, a voice coil, and two lower vibrating diagrams; and
the inner vibrating diagram is disposed above the outer magnetic steel, the framework is disposed at a periphery of the inner vibrating diagram, the upper vibrating diagram is disposed at a periphery of the framework, the voice coil is suspended in the gap, and the two lower vibrating diagrams are respectively disposed at outer sides of the two third side plates.

7. The speaker module according to claim 6, wherein the speaker module further comprises two flexible circuit boards (FCBs), the two FCBs are respectively disposed on the two lower vibrating diagrams and are electrically connected to the voice coil, the framework is connected to the two FCBs and is configured to support the vibration system on the two FCBs, and each of the two lower vibrating diagrams is concave from top to bottom.

8. The speaker module according to claim 7, wherein the framework comprises a fourth main body and two fourth side plates, the fourth main body is connected between the inner vibrating diagram and the upper vibrating diagram, the two fourth side plates are respectively vertically disposed at side edges, corresponding to the two FCBs, of the fourth main body, and the two fourth side plates are respectively connected to inner sides of the two FCBs; and
the upper vibrating diagram comprises a fifth main body and two fifth side plates, the fifth main body is connected to the workframe, the two fifth side plates are respectively vertically disposed at side edges, corresponding to the two FCBs, of the fifth main body, and the two fifth side plates are respectively connected to outer sides of the two FCBs.

9. The speaker module according to claim 2, wherein connecting lugs are disposed on side edges, corresponding to the two second side plates, of the first main body, a top portion of each of the two second side plates defines a second mounting groove, and each second mounting groove is matched with a corresponding one of the connecting lugs.

10. The speaker module according to claim 1, wherein the damping structure is a flexible damping structure, and the anti-overflow layer is a flexible glue layer.
